(19) United States
(12) Patent Application Publication
(10) Pub. No.: US 2025/0203226 A1
(43) Pub. Date: Jun. 19, 2025

(54) ELECTRONIC DEVICE AND IMAGING APPARATUS

(71) Applicant: Panasonic Intellectual Property Management Co., Ltd., Osaka (JP)

(72) Inventors: Kohei YAMAMOTO, Nara (JP); Shohei KINUTA, Osaka (JP)

(73) Assignee: Panasonic Intellectual Property Management Co., Ltd., Osaka (JP)

(21) Appl. No.: 18/972,885

(22) Filed: Dec. 7, 2024

(30) Foreign Application Priority Data
Dec. 18, 2023 (JP) 2023-213202

(51) Int. Cl. H04N 23/84; H04N 23/661

(52) U.S. Cl. CPC H04N 23/84; H04N 23/661

(57) ABSTRACT

An electronic device communicates with an external imaging apparatus and includes: a communication circuit that communicates data with the imaging apparatus; an input interface that receives input by a user operation; a controller that controls the communication circuit; and a storage that stores a first library including one or more sets of color conversion data each defining a correspondence before and after color information in an image is converted. The imaging apparatus stores a second library including one or more sets of the color conversion data managed in the imaging apparatus. The controller receives, from the imaging apparatus via the communication circuit, management information managing the color conversion data in the second library, and generates an instruction according to a user operation on the second library to transmit the instruction to the imaging apparatus via the communication circuit, based on the management information received from the imaging apparatus.

### TECHNICAL FIELD

The present disclosure relates to an electronic device and an imaging apparatus capable of communicating with each other and using color conversion data such as a look-up table (LUT) applied to an image.

### BACKGROUND ART

JP 2007-221606 A discloses a system that sets, to both an imaging device and a development application, image processing parameters downloaded from an external device such as a center server. The system sets image processing parameter files downloaded by a personal computer (PC) to the imaging device connected to the PC. The development application is installed in the PC. The PC displays a selection screen for selecting the image processing parameters, and in a case where model information included in data of a file selected from the image processing parameter files corresponds to model information acquired through communication with the connected imaging device, transfers the data to the imaging device.

### SUMMARY

The present disclosure provides an electronic device and an imaging apparatus that can facilitate management of color conversion data.

An electronic device in the present disclosure communicates with an external imaging apparatus. The electronic device includes a communication circuit that communicates data with the imaging apparatus, an input interface that receives input by a user operation, a controller that controls the communication circuit, and a storage that stores a first library including one or more sets of color conversion data each defining a correspondence before and after color information in an image is converted. The imaging apparatus stores a second library including one or more sets of the color conversion data managed by the imaging apparatus. The controller receives management information from the imaging apparatus via the communication circuit, the management information managing the color conversion data in the second library. The controller generates an instruction according to a user operation on the second library to transmit the instruction to the imaging apparatus via the communication circuit, based on the management information received from the imaging apparatus.

An imaging apparatus according to the present disclosure communicates with an external an electronic device. The imaging apparatus includes circuit that communicates data with the electronic device, a storage that stores a library including one or more sets of color conversion data each defining a correspondence before and after color information in an image is converted, and a controller that controls the communication circuit. The controller transmits, to the electronic device via the communication circuit, management information managing the color conversion data in the library. The controller receives, from the electronic device via the communication circuit, an instruction generated in the electronic device according to a user operation on the library based on the management information. The controller transmits, to the electronic device via the communication circuit, updated management information based on the instruction received from the electronic device.

According to the electronic device and the imaging apparatus of the present disclosure, the color conversion data can be easily managed.

### BRIEF DESCRIPTION OF THE DRAWINGS

FIG. 1 is a view illustrating a configuration example of a LUT management system according to a first embodiment;

FIG. 2 is a block diagram illustrating a configuration example of a user terminal in the LUT management system;

FIG. 3 is a block diagram illustrating a configuration example of a digital camera in the LUT management system;

FIG. 4 is a view for explaining LUT libraries in the digital camera and the user terminal;

FIG. 5 is a view illustrating an example of LUT library information in the digital camera;

FIG. 6 is a sequence diagram for explaining operation of the user terminal and the digital camera;

FIG. 7 is a view for explaining LUT transfer operation;

FIG. 8 is a view for explaining LUT rearrangement operation;

FIGS. 9A to 9E are views each illustrating a display example of transfer operation in the user terminal;

FIGS. 10A and 10B are views each illustrating a display example of another operation using camera library information in the user terminal;

FIG. 11 is a view illustrating an example of a LUT file according to a second embodiment;

FIG. 12 is a flowchart indicating transfer operation in the user terminal of the second embodiment; and

FIG. 13 is a view illustrating a display example of the transfer operation in the user terminal of the second embodiment.

### DETAILED DESCRIPTION

Hereinafter, embodiments will be described with reference to the drawings as appropriate. However, unnecessarily detailed description may be omitted. Note that the accompanying drawings and the following description are provided in order for those skilled in the art to fully understand the present disclosure and do not intend to limit the subject matter described in the claims by the accompanying drawings and the following description.

### First Embodiment

### 1. Configuration

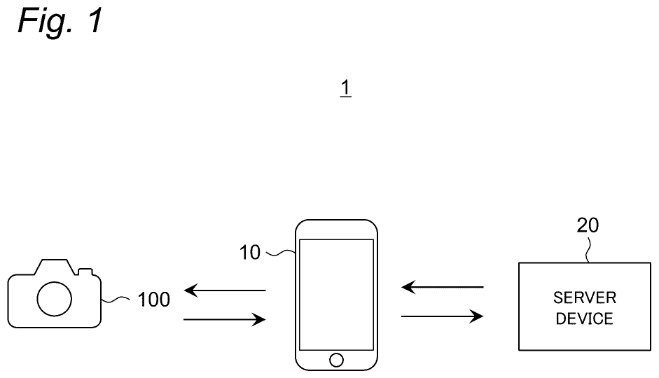

FIG. 1 is a block diagram illustrating a configuration example of a LUT management system 1 according to a first embodiment of the present disclosure. The LUT management system 1 includes a user terminal 10 and a server device 20. The user terminal 10 is, for example, an electronic device such as a smartphone, a tablet terminal, or a personal computer. The user terminal 10 may be a digital camera or an electronic device with a camera function. The user terminal 10 and the server device 20 are communicably connected via, for example, a communication network.

### 1-1. Configuration of User Terminal

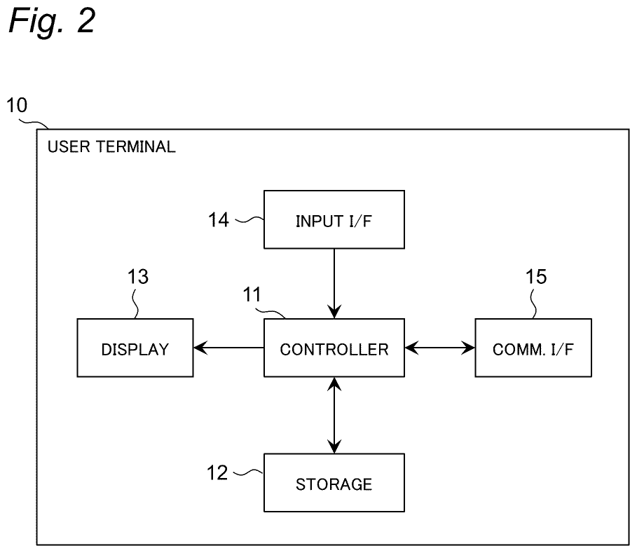

FIG. 2 is a block diagram illustrating a configuration example of the user terminal 10.

The user terminal 10 includes a controller 11, a storage device 12, a display 13, an input interface (I/F) 14, and a communication interface (I/F) 15.

The controller 11 performs information processing to achieve a function of the user terminal 10. Such information processing is achieved, for example, by the controller 11 operating according to a program stored in the storage device 12. The controller 11 includes an arithmetic circuit that performs arithmetic operation for information processing. For example, the controller 11 is constituted with, for example, a circuit such as a CPU, an MPU or an FPGA.

The storage device 12 is a recording medium that records various kinds of information including a program for achieving the function of the user terminal 10. The storage device 12 is implemented by, for example, a semiconductor storage device such as a flash memory or a solid state drive (SSD), a magnetic storage device such as a hard disk drive (HDD), or other recording media alone or in combination thereof. The storage device 12 may include a volatile memory such as an SRAM or a DRAM.

The display 13 is a display device capable of displaying information, and includes, for example, a liquid crystal display, an organic EL display, and the like.

The input interface 14 is an example of an input interface that connects the user terminal 10 and input equipment in order to input information from the input equipment such as a touch panel, a touch pad, a keyboard, a mouse, or a pointing device to the user terminal 10. For example, the input interface 14 receives an operation by a user via the input equipment.

The communication interface 15 is a communication circuit that performs wireless or wired communication in accordance with communication standards. The communication interface 15 can be connected to a communication network such as an intranet or the Internet, and can receive information from external equipment such as the server device 20 and transmit the information to the external equipment. Alternatively, the communication interface 15 may directly communicate with external equipment without the network.

### 1-2. Configuration of Digital Camera

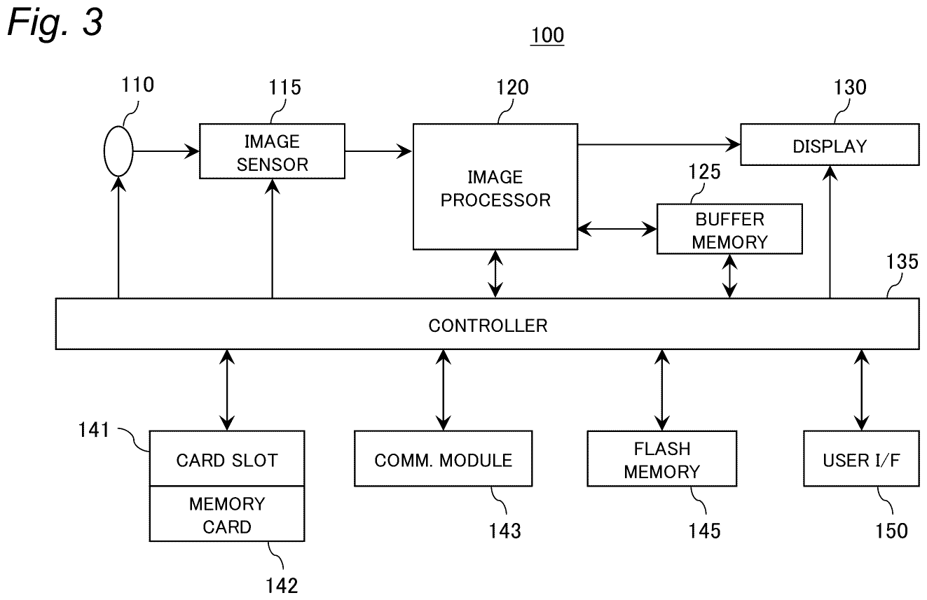

FIG. 3 is a block diagram illustrating a configuration example of a digital camera 100.

The digital camera 100 captures a subject image formed via an optical system 110 with an image sensor 115 to generate original image data (RAW data). An image processor 120 performs various kinds of processing on the RAW data generated by the image sensor 115 to generate image data. A controller 135 records the image data generated by the image processor 120 in a flash memory 145 or a memory card 142 inserted into a card slot 141. In addition, the controller 135 can display (playback) the image data recorded in the flash memory 145 or the memory card 142 on a display 130 according to a user operation on a user interface 150.

The optical system 110 includes a focus lens, a zoom lens, an optical image stabilization lens (OIS), a diaphragm, a shutter, and the like. The various lenses included in the optical system 110 may include any number of lenses or any number of groups.

The image sensor 115 captures a subject image formed through the optical system 110 to generate RAW data. The image sensor 115 generates image data of a new frame at a predetermined frame rate (for example, 30 frames/second). A generation timing of the RAW data and electronic shutter operation in the image sensor 115 are controlled by the controller 135. Note that, as the image sensor 115, various image sensors such as a CMOS image sensor, a CCD image sensor, or an NMOS image sensor may be used. The image sensor 115 is an example of an image sensor in the present embodiment.

The image processor 120 performs various kinds of processing on the RAW data output from the image sensor 115 to generate image data. Further, the image processor 120 performs various kinds of processing on the image data read from the memory card 142 to generate an image to be displayed on the display 130. Examples of the various kinds of processing include, but are not limited to, white balance correction, gamma correction, YC conversion processing, electronic zoom processing, compression processing, decompression processing, image processing using a lookup table (LUT), and the like. The image processor 120 may be implemented with a hard-wired electronic circuit or a microcomputer using a program.

The display 130 is a display device such as a liquid crystal display or an organic EL display capable of displaying information. For example, the display 130 displays an image based on the image data processed by the image processor 120. Further, the display 130 displays a menu screen for the user to confirm the setting of the digital camera 100.

The controller 135 integrally controls the entire operation of the digital camera 100. The controller 135 may include a processor configured to achieve a predetermined function by executing a program. For example, the controller 135 can be implemented by various processors such as a CPU, an MPU, a GPU, a DSU, an FPGA, and an ASIC. The controller 135 may include one or more processors. Furthermore, the controller 135 may include one semiconductor chip together with the image processor 120, and the like. Although not illustrated, the controller 135 includes a ROM. The ROM stores various programs such as autofocus control (AF control) to be executed by the controller 135. In addition, the controller 135 incorporates a RAM (not illustrated) that functions as a work area of the CPU.

A buffer memory 125 is a recording medium that functions as a work memory of the image processor 120 and the controller 135. The buffer memory 125 is implemented by a dynamic random access memory (DRAM), or the like.

The memory card 142 is detachably inserted into the card slot 141. The card slot 141 can be electrically and mechanically connected to the memory card 142. The memory card 142 is an external memory including a recording element such as a flash memory therein. The memory card 142 can store data such as a LUT and image data generated by the image processor 120.

A communication module 143 performs data communication according to existing wired communication standards or wireless communication standards. For example, the digital camera 100 can communicate with a communication network such as the Internet, and/or another device equipped with a Wi-Fi (registered trademark) module, a Bluetooth (registered trademark) module or the like via the communication module 143. The digital camera 100 may directly communicate with another device via the communication module 143 or may communicate via an access point.

The flash memory 145 is a non-volatile recording medium. The flash memory 145 can store various kinds of data such as a LUT to be described below, LUT library information for managing the LUTs, and image data.

The LUT is an array (parameter set) that defines a correspondence relationship before and after color information for each pixel in the input image is converted. The LUT is, for example, a three-dimensional lookup table indicating a relationship between input and output color data including a combination of three colors of RGB. The image processor 120 performs image processing to convert color of the input image data into color of output image data by referring to the LUT. For example, the LUTs are downloaded by an information processing device from the server device 20 that stores the LUTs and are stored in advance in the flash memory 145 of the digital camera 100 via the memory card 142.

The user interface (I/F) 150 is a general term of various user interfaces such as a hardware key and a software key of the digital camera 100 and receives an operation by the user. The user interface 150 includes, for example, a button, a mode dial, a touch panel, and a switch. When the operation by the user is received, the user interface 150 transmits an operation signal corresponding to the user operation to the controller 135.

### 1-3. LUT Library

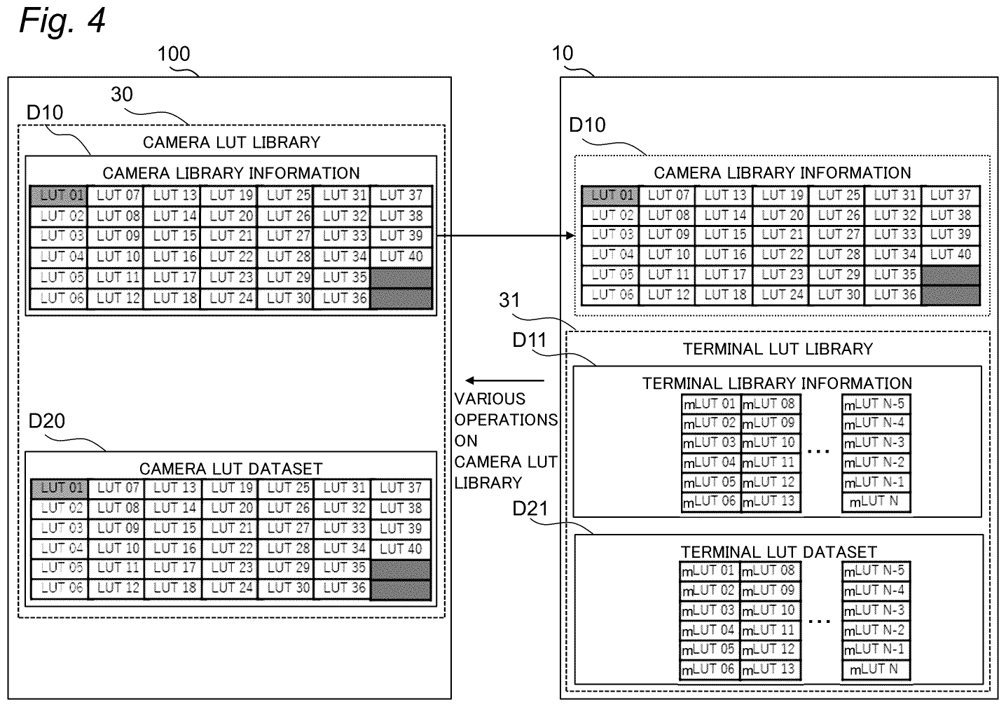

FIG. 4 is a view for explaining LUT libraries of the user terminal 10 and the digital camera 100. In the LUT management system 1 according to the present exemplary embodiment, the user terminal 10 and the digital camera 100 manage LUTs in LUT libraries each capable of storing a plurality of LUTs. For example, in the digital camera 100, as a camera LUT library 30, camera library information D10 and a camera LUT dataset D20 are stored in the flash memory 145 in association with each other. As a terminal LUT library 31 in the user terminal 10, terminal library information D11 and a terminal LUT dataset D21 including a plurality of LUTs are stored in association with each other in the storage device 12.

For example, as illustrated in FIG. 4, each of the LUT datasets D20, D21 may include a plurality of LUTs. The camera library information D10 is LUT library information managing the LUTs of the camera LUT dataset D20. The terminal library information D11 is LUT library information managing the LUTs of the terminal LUT dataset D21.

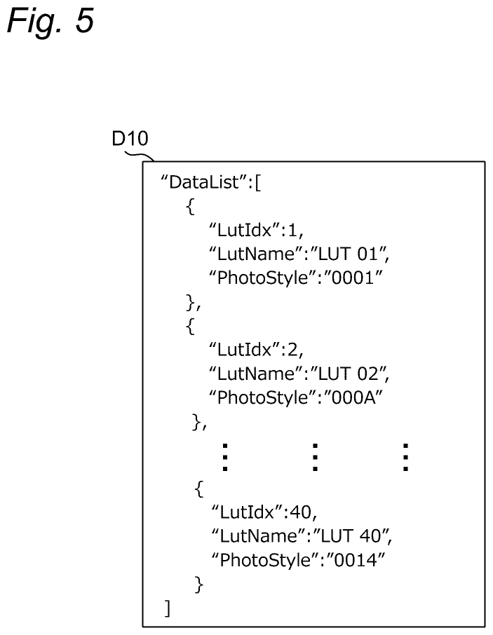

FIG. 5 is a view illustrating an example of the camera library information D10 as the LUT library information in the digital camera 100. For example, the camera library information D10 includes, for each LUT, items such as “LutIdx” as an index number indicating a position where the LUT is stored in the camera LUT dataset D20 and “LutName” indicating a name of the LUT, and manages the LUTs by values of the respective items. Furthermore, the camera library information D10 of the present example includes an item of “PhotoStyle” as a parameter for specifying a photo style of an image to be a base to which each LUT is applied.

The photo style is configured as a parameter set of image adjustment for adjusting the image indicated by the RAW data, in accordance with each of a plurality of imaging modes prepared in advance, so that the digital camera 100 can easily capture an image in a color tone and image quality intended by the user.

The camera library information D10 of the present embodiment illustrated in FIG. 5 can manage 40 LUTs. The terminal library information D11 in the user terminal 10 can be configured similarly to the camera library information D10, for example, except that 40 or more LUTs can be managed in the present embodiment.

### 2. Operation

Operation of the user terminal 10 and the digital camera 100 configured as described above will be described below.

In the present system 1, the user terminal 10 and the digital camera 100 perform data communication conforming to, for example, Wi-Fi and/or Bluetooth standards. The user terminal 10 acquires the camera library information D10 from the digital camera 100 via the data communication and transmits, to the digital camera 100, an instruction according to various user operations on the camera LUT library 30 based on the acquired camera library information D10. By using the acquired camera library information D10 by the user terminal 10 in this manner, the user can perform various operations on the camera LUT library 30.

For example, the user terminal 10 transfers the LUT of the terminal LUT dataset D21 to the digital camera 100 according to a user operation. Therefore, the user terminal 10 can transfer a LUT stored in the terminal LUT dataset D21, the LUT being downloaded from the server device 20 or the like, and write the LUT in the camera LUT dataset D20.

For example, according to the transfer of the LUT as described above, it is possible to use various LUTs, saving an effort such that the user once saves, in the memory card 142, a LUT downloaded by the information processing device or the like, and then copies the LUT to the flash memory 145 of the digital camera 100. As described above, according to the user terminal 10 and the digital camera 100 of the present embodiment, various user operations can be performed by the user terminal 10 on the camera LUT library 30, so that the LUTs can be easily managed.

### 2-1. Overall Operation

Overall operation of the user terminal 10 and the digital camera 100 of the present embodiment will be described with reference to FIGS. 4 to 8.

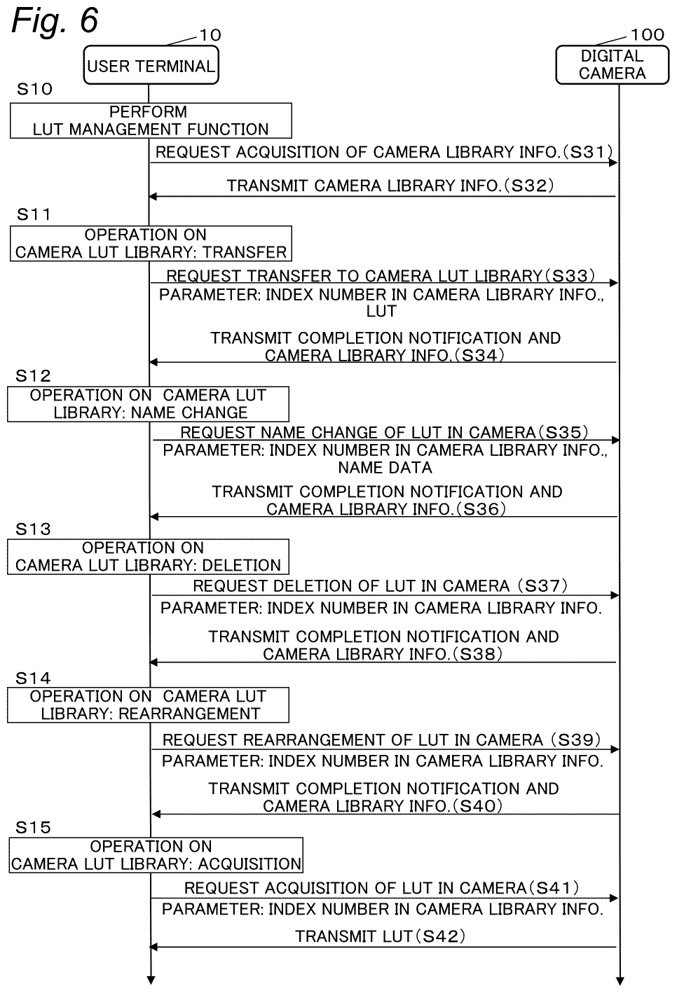

FIG. 6 is a sequence diagram for explaining operation of the user terminal 10 and the digital camera 100. The user terminal 10 of the present embodiment has a function to manage the LUTs in the camera LUT library 30 in addition to the terminal LUT library 31. Each process indicated in FIG. 6 is performed, for example, in such a LUT management function, by the controller 11 controlling respective components in the user terminal 10 and by the controller 135 controlling respective components in the digital camera 100.

For example, the user terminal 10 starts execution of the LUT management function in response to receiving a predetermined user operation in the input I/F 14 (S10). First, the user terminal 10 requests the digital camera 100 to acquire the camera library information D10 via the communication I/F 15 (S31). In response to the request, the digital camera 100 transmits the camera library information D10 to the user terminal 10 via the communication module 143 (S32). The user terminal 10 displays a menu screen on the display 13 based on the received camera library information D10, the menu screen being displayed for receiving inputs by various operations on the camera LUT library 30 via the input I/F 14, for example. Details of the operation in the user terminal 10 will be described below.

Hereinafter, an example in which various operations are performed on the camera LUT library 30 based on the camera library information D10 acquired in step S10 in the user terminal 10 will be described.

### (1) Transfer of LUT to Digital Camera

The user terminal 10 receives the user operation to transfer a LUT from the terminal LUT dataset D21 to the camera LUT library 30 (S11) and requests transfer of the LUT designated by the user operation to the digital camera 100, for example (S33). In such a transfer request, the user terminal 10 generates and transmits an instruction based on the camera library information D10, the instruction including, as parameters, an index number in the camera LUT library 30 designated as a transfer destination by the user operation and the designated LUT (S33).

In response to the transfer request from the user terminal 10 in step S33, the digital camera 100 writes and stores the transferred LUT at a position indicated by the specified index number of the camera LUT dataset D20. For example, the digital camera 100 transmits, to the user terminal 10 via the communication module 143, a completion notification and the camera library information D10 updated according to the writing (S34). The completion notification indicates that the write process is normally completed.

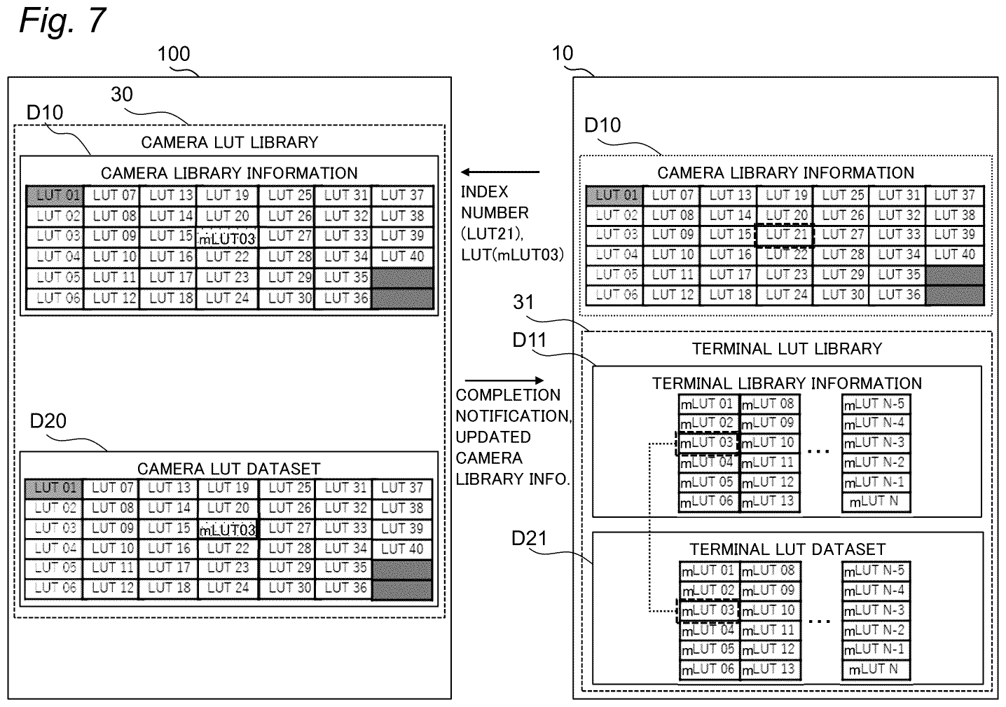

FIG. 7 is a view for explaining such LUT transfer operation. FIG. 7 illustrates an example in which transfer operation is performed in the user terminal 10 based on the camera library information D10 acquired from the digital camera 100 in the example of FIG. 4. In the example of FIG. 7, by the user terminal 10, an index number of “LUT 21” as the transfer destination and a LUT “mLUT03” to be transferred from the terminal LUT dataset D21 are designated based on the acquired camera library information D10. In this case, the user terminal 10 makes the transfer request including, as parameters, the index number of the designated transfer destination and the LUT to be transferred (S33).

In response to the received transfer request, the digital camera 100 changes a name corresponding to the designated index number in the camera library information D10 as illustrated in FIG. 5 to the name of the transferred LUT. The digital camera 100 writes the transferred LUT to a position corresponding to the index number in the camera LUT dataset D20 and transmits the completion notification and the like (S34).

### (2) Name Change of LUT

Further, the user terminal 10 receives a user operation changing the name of the LUT in the camera LUT library 30 (S12) and requests the digital camera 100 to change the name of the LUT specified by the user operation (S35). In such a name change request, an instruction including parameters is transmitted, the parameters including the index number of the LUT designated in the camera library information D10 by the user operation and name data indicating the name after the change (S35).

For example, the user terminal 10 makes the name change request including the index number and the name data of the LUT in response to the user operation changing the name of “LUT 21” of the camera LUT library illustrated in FIG. 4 to “mLUT 03” (S35). In response to the name change request, based on the received name data, the digital camera 100 changes the name corresponding to the index number designated in the camera library information D10. For example, similarly to the response to the transfer request (S34), the digital camera 100 transmits a completion notification of the name change and the updated camera library information D10 to the user terminal 10 (S36).

### (3) Deletion of LUT

The user terminal 10 receives a user operation to delete the LUT of the camera LUT library 30 (S13) and requests the digital camera 100 to delete the LUT (S37). The user terminal 10 generates and transmits an instruction including, as a parameter in a deletion request, the index number of a LUT designated in the camera library information D10 as a deletion target by the user operation (S37). For example, in response to the user operation instructing deletion of the “LUT 21” in the camera library information D10 illustrated in FIG. 4, the instruction including the index number of the LUT in the deletion request is transmitted.

In response to the received deletion request, for example, in the camera library information D10 illustrated in FIG. 5, the digital camera 100 changes a value such as a name corresponding to the designated index number to a default value or the like indicating that no value is written. Then, the digital camera 100 transmits a deletion completion notification and the updated camera library information D10 to the user terminal 10 (S38). By this operation, for example, even when the LUT indicated by the index number is not deleted in the camera LUT dataset D20, the digital camera 100 can manage the LUT as being deleted based on the changed camera library information D10.

### (4) Rearrangement of LUTs

The user terminal 10 receives a user operation changing and rearranging positions of the LUTs stored in the camera LUT library 30 (S14) and requests the digital camera 100 to rearrange the LUTs (S39). For example, the user terminal 10 makes a rearrangement request including the index number of the LUT selected in the camera library information D10 by the user operation and the index number designated as a movement destination of the LUT as parameters (S39).

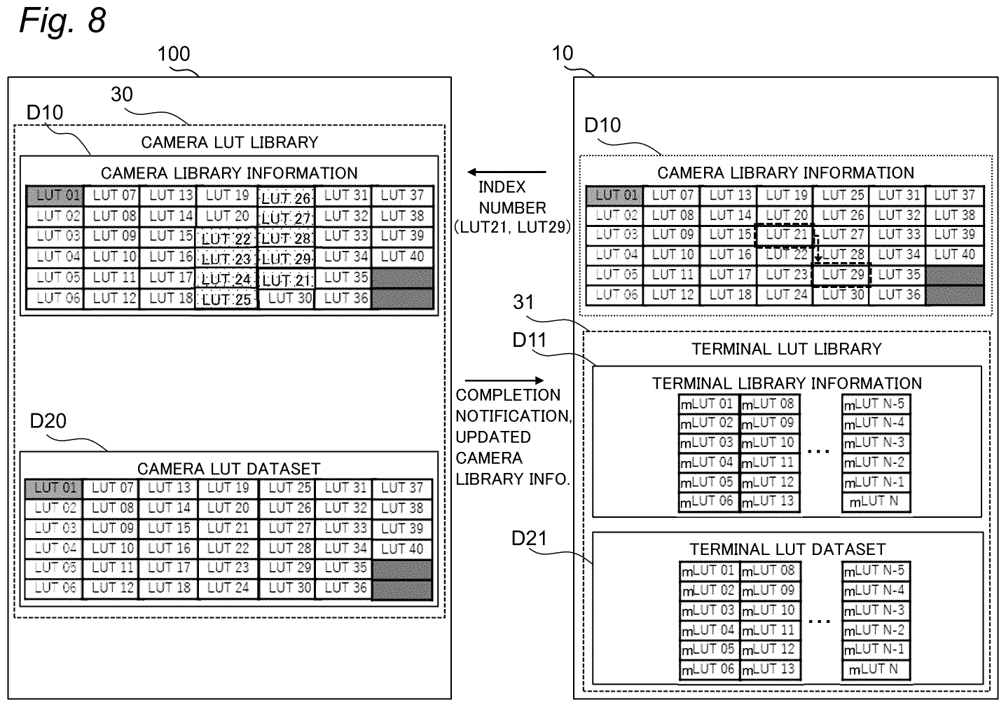

FIG. 8 is a view for explaining such LUT rearrangement operation. FIG. 8 illustrates an example in which the user operation instructing rearrangement to move “LUT 21” to a position of “LUT 29” is input based on the camera library information D10 acquired by the user terminal 10 in the example of FIG. 4. When the rearrangement request including the two index numbers from the user terminal 10 (S39), the digital camera 100 moves the index number of the “LUT 21” and updates the camera library information D10 so as to increment subsequent index numbers, for example. The digital camera 100 transmits a completion notification of the rearrangement and the updated camera library information D10 to the user terminal 10 (S40).

By the rearrangement operation as described above, the digital camera 100 can manage the LUTs at positions in the updated camera library information D10 without rearranging the LUTs of the camera LUT dataset D20. Therefore, for example, the user operation by the user terminal 10 to instruct the rearrangement is quickly reflected, and the user terminal 10 can achieve the operation on the camera LUT library in real-time. Furthermore, in the digital camera 100, for example, the LUTs themselves do not need to be rearranged, so that processing load can be reduced. As described above, for example, LUTs can be easily managed in terms of processing speed, processing load, and the like in the user terminal 10 and the digital camera 100.

### (5) Acquisition of LUT

The user terminal 10 receives a user operation to acquire the LUT of the camera LUT library 30 (S15) and requests the digital camera 100 to acquire the LUT specified by the user operation, for example (S41). Based on the camera library information D10, the user terminal 10 transmits an instruction including the index number of the designated LUT as a parameter in an acquisition request (S41). In response to the acquisition request, the digital camera 100 transmits the LUT of the index number from the camera LUT dataset D20 to the user terminal 10 (S42). For example, the camera library information D10 is not updated by the acquisition request, but may be transmitted together with the LUT.

For example, in response to a user operation instructing acquisition of “LUT 21” in the camera library information D10 of FIG. 4, the LUT is transmitted to the user terminal 10 in response to the acquisition request including the index number of the LUT (S41) (S42). The user terminal 10 of the present embodiment adds the acquired LUT to a position at the end of the terminal LUT dataset D21 and adds the index number of the LUT to the end of the terminal library information D11.

The digital camera 100 may convert a data format of the LUT before transmission in step S42. For example, in a case where a format such as cube or VLT is available for a LUT file describing a LUT in the digital camera 100, and only cube is available in the user terminal 10, the LUT in VLT may be converted into cube. Furthermore, for example, when converting, information indicating a base photo style may be added based on the camera library information D10 (see FIG. 5). Furthermore, in the digital camera 100, when the LUT is received from the user terminal 10 by the above-described transfer operation of the LUTs, an operation selecting the format of the LUT to be stored in the flash memory 145 may be received, and data conversion may be performed according to a selection result by the user.

According to the above operation, based on the camera library information D10 acquired from the digital camera 100, the user terminal 10 transmits the instructions according to the various user operations on the camera LUT library 30 and receives responses from the digital camera 100 (S33 to S42). The user operation includes transfer, name change, deletion, rearrangement, and acquisition of the LUT (S12 to S15). For example, by acquiring and using the camera library information D10 consistent with the camera LUT library 30 in response to the execution of the LUT management function (S10) and the update after the various operations input by the user terminal 10, it is possible to generate instructions according to the various operations according to a state of the camera LUT library 30.

Furthermore, in the digital camera 100, for example, the LUT copied from the memory card 142 to the flash memory 145 and the LUT transferred from the user terminal 10 by the transfer operation can be stored in a mixed manner. Also in such a case, according to the digital camera 100 of the present embodiment, the camera library information D10 is transmitted in response to the request from the user terminal 10 or the various user operations on the camera LUT library 30 (S31, S32, S34, S36, S38, S40). Therefore, for example, the LUTs in the digital camera 100 can be easily managed by the instruction based on the camera library information D10 from the user terminal 10.

The various operations (S11 to S15) input by the user terminal 10 on the camera LUT library are not limited to the order described in the example of FIG. 6, and can be executed in an arbitrary order, and corresponding processing (S33 to S42) is executed according to each operation.

### 2-2. Operation of User Terminal

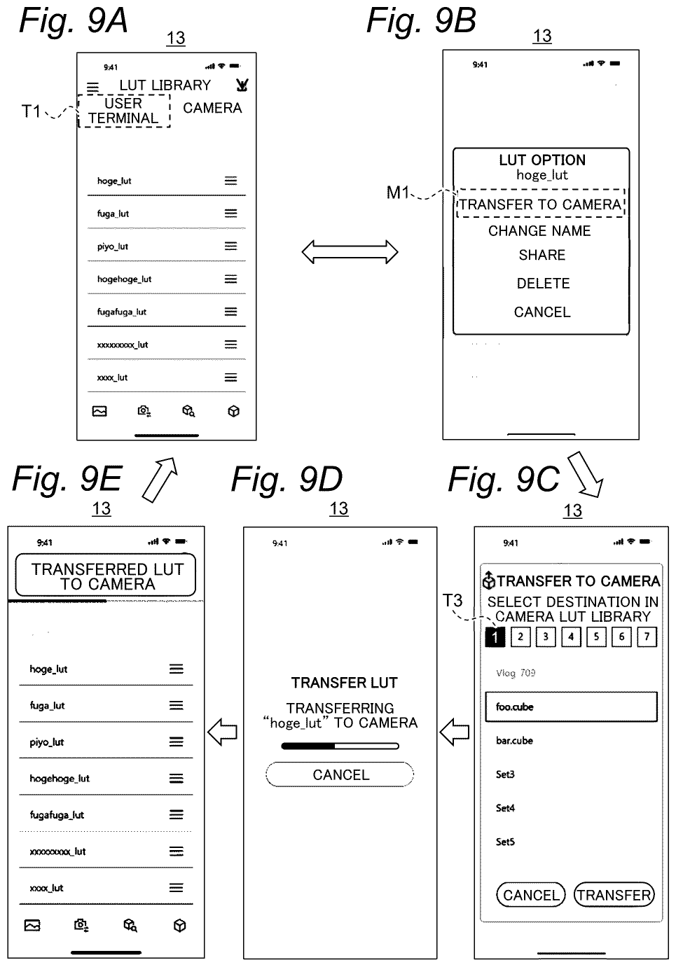

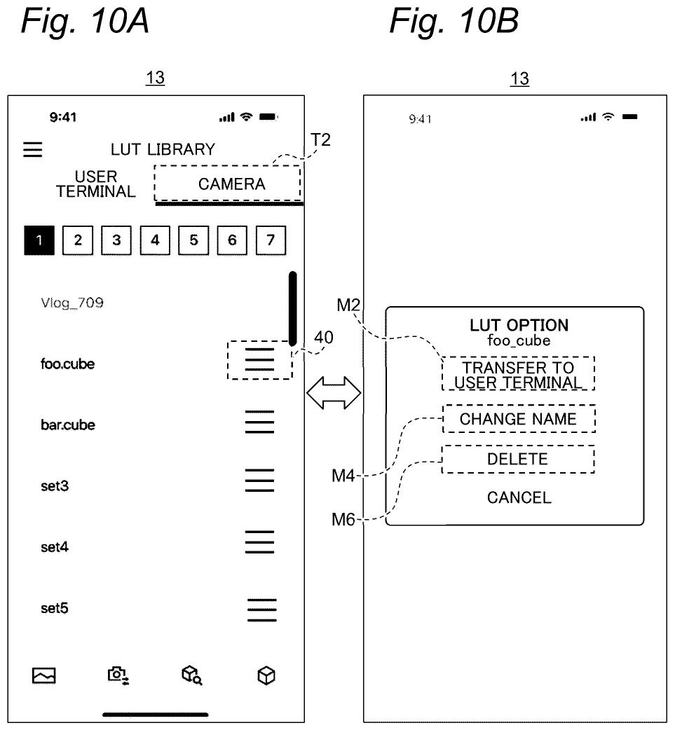

The user terminal 10 of the present embodiment achieves the LUT management function by, for example, an application stored in advance in the storage device 12. Such operation of the user terminal 10 will be described with reference to FIGS. 9 and 10.

FIGS. 9A to 9E are views each illustrating a display example of transfer operation in the user terminal 10. FIG. 9 illustrates an application screen displayed on the display 13 by the controller 11 in the user terminal 10. For example, when the LUT management function is executed (S10 in FIG. 6), the controller 11 acquires the camera library information D10 (S31, S32) and executes the application.

FIG. 9A illustrates an example in which names of the LUTs in the terminal LUT dataset D11 are displayed in a list based on the terminal library information D21 in a state where a tab T1 for displaying the terminal LUT library 31 is selected. The display 13 transitions from the screen illustrated in FIG. 9A to a screen of FIG. 9B in response to a user operation selecting the name of the LUT by tapping or the like, the user operation being input via the input I/F 14.

On the screen of FIG. 9B, various menu items are displayed as options of functions executable for the selected LUT. When a menu item M1 for transferring the LUT to the digital camera 100 is selected by the user operation, the display 13 transitions to a screen of FIG. 9C. FIG. 9C illustrates a display example of a screen for selecting the transfer destination in the camera LUT library 30. For example, the controller 11 displays LUTs of the camera LUT library based on the acquired camera library information D10 over a plurality of pages each displaying a predetermined number of LUTs. In the example of FIG. 9C, the first page is selected by a tab T3 for switching the page.

For example, when the LUT having the name “foo.cube” is selected on the screen of FIG. 9C, the display 13 transitions to a screen of FIG. 9D. The screen of FIG. 9D indicates that the LUT selected on the screen of FIG. 9A is being transferred to a position corresponding to the LUT in the camera LUT library 30. In response to the selection of the LUT to be transferred and the transfer destination, the controller 11 transmits the LUT and the index number of the transfer destination to the digital camera 100 via the communication I/F 15 (S33 in FIG. 6).

For example, in response to the completion notification (S34) from the digital camera 100, the display 13 transitions from the screen of FIG. 9D to a screen of FIG. 9E. In the example of FIG. 9E, the display 13 displays a message indicating the completion notification above the terminal LUT library 31. For example, after a predetermined period (5 seconds, or the like) passes, the display 13 returns to the screen of FIG. 9A. Furthermore, from each of the screens of FIGS. 9B to 9D, the screen can be returned to the screen before the transition by a user operation of selecting an item of “cancel”, for example.

FIGS. 10A and 10B are views each illustrating a display example of another operation using the camera library information D10 in the user terminal 10. In the example of FIG. 10A, the display 13 displays the name of each LUT in the camera library information D10 in a state where a tab T2 for displaying the LUT of the camera LUT library 30 is selected. For example, the controller 11 generates the instruction to rearrange the LUTs in response to receiving the user operation dragging and moving a rearrangement icon 40 displayed for each LUT via the input I/F 14 (S14) (S39).

The display 13 transitions to a screen of FIG. 10B in response to a user operation selecting the name of the LUT on the screen of FIG. 10A. On the screen of FIG. 10B, the display 13 displays menu items M2, M4, and M6 for receiving the user operations respectively for acquisition (S15), name change (S12), and deletion (S13) by the user terminal 10, for the LUT selected on the screen of FIG. 10A.

By the operation using the application screen as described above, the user can easily manage the LUTs by the familiar operation in the user terminal 10 such as a smartphone. The above application may be provided via a communication network such as the Internet or may be downloaded to the user terminal 10 via the communication I/F 15.

### 3. Effects

As described above, the user terminal 10 as an example of the electronic device in the present embodiment communicates with the digital camera 100 as an example of an external imaging apparatus. The user terminal 10 includes the communication I/F 15 as an example of a communication circuit communicates data with the digital camera 100, the input I/F 14 as an example of an input interface that receives input by a user operation, the controller 11 that controls the communication I/F 15, and the storage device 12 as an example of a storage. The storage device 12 stores the terminal LUT library 31 as an example of a first library including a plurality of LUTs in the terminal LUT dataset D21 as an example of one or more sets of color conversion data each defining a correspondence before and after color information in an image is converted. The digital camera 100 stores the camera LUT library 30 as an example of a second library including a plurality of LUTs in the camera LUT dataset D20 as an example of one or more sets of the color conversion data managed in the digital camera 100. The controller 11 receives the camera library information D10 from the digital camera 100 via the communication I/F 15, the camera library information D10 being an example of management information managing the LUTs in the camera LUT library 30 (S31, S32). Based on the camera library information D10 received from the digital camera 100, the controller 11 generates an instruction according to the user operation on the camera LUT library 30 to transmit the instruction to the digital camera 100 via the communication I/F 15 (S11 to S15, S33, S35, S37, S39, S41).

According to the user terminal 10 described above, based on the camera library information D10 acquired from the digital camera 100, an instruction according to the user operation on the camera LUT library 30 can be achieved, and for example, the LUTs stored in the digital camera 100 can be easily managed.

In the present embodiment, the controller 11 transmits the LUT designated from the terminal LUT library 31 to the digital camera 100 via the communication I/F 15 in response to an instruction according to user operation designating the LUT to be added from the terminal LUT library 31 to the camera LUT library 30 based on the camera library information D10 (S11, S33). Therefore, for example, the LUT acquired from the server device 20, or the like, by the user terminal 10 can be transferred to the digital camera 100.

In the present embodiment, based on the camera library information D10, the controller 11 transmits the LUT designated from the terminal LUT library 30 to a position selected by the user operation among positions where a plurality of LUTs are stored in the camera LUT library 31 (S33). For example, by including, in the parameters of the transfer request from the user terminal 10, the index number selected as the position of the transfer destination in the camera LUT library 30 and transmitting the parameters, the LUT can be transferred to the position intended by the user.

In the present embodiment, the controller 11 requests designated LUT in the camera LUT library 30 from the digital camera 100 based on the camera library information D10, to receive the designated LUT from the digital camera 100 via the communication I/F 15, in accordance with the instruction according to the user operation designating the LUT to be acquired from the camera LUT library 30 (S15, S41, S42). Therefore, in the user terminal 10, the LUT of the camera LUT library 30 designated by the user operation can be acquired.

In the present embodiment, the camera library information D10 includes index numbers as an example of positions where a plurality of LUTs are stored in the camera LUT library 30. Based on the camera library information D10, the controller 11 generates, according to the user operation changing the positions, the instruction including the correspondence before and after the positions are changed, and transmits the instruction to the digital camera 100 via the communication I/F 15 (S14, S39). For example, the LUTs of the camera LUT library 30 are rearranged according to the user operation input by the user terminal 10, in response to the rearrangement request including, as parameters, the index numbers in the camera library information D10 respectively indicating a LUT for which the position is to be changed and the position of a destination for the change. Therefore, it is possible to easily manage the LUTs according to preference of the user, such as frequency of use, for example.

In the present embodiment, the camera library information D10 includes names associated with the LUTs in the camera LUT library 30. Based on the camera library information D10, the controller 11 generates, according to the user operation changing the name of the LUT in the camera LUT library 30, the instruction including the name data as an example of the changed name after the change of the LUT, and transmits the instruction to the digital camera 100 via the communication I/F 15 (S12, S35). Therefore, for example, in the digital camera 100, the name in the camera library information D10 can be updated based on the received instruction and the name of the LUT in the camera LUT library 30 can be changed according to the user operation in the user terminal 10.

In the present embodiment, the controller 11 generates the instruction according to the user operation specifying a LUT to be deleted from the camera LUT library 30, and transmits the instruction to the digital camera 100 via the communication I/F 15, based on the camera library information D10 (S13, S37). Therefore, for example, the LUT to be deleted can be specified by the index number in the camera library information D10, and the LUT intended by the user can be deleted.

In the present embodiment, the controller 11 requests the camera library information D10 from the digital camera 100 (S31) to receive the camera library information D10 from the digital camera 100, via the communication I/F 15 (S32). Based on the camera library information D10 acquired in this manner, the user terminal 10 can generate the instructions consistent with the state of the camera LUT library 30 according to the above-described various user operations.

The digital camera 100 as an example of the imaging apparatus in the present embodiment communicates with the user terminal 10 as an example of an external electronic device. The digital camera 100 includes the communication module 143 as an example of a communication circuit that communicates data with the user terminal 10, the flash memory 145 as an example of a storage, and the controller 135 as an example of a controller that controls the communication module 143. The flash memory 145 stores the camera LUT library 30 (an example of a library) including a plurality of LUTs in the camera LUT dataset D20 as an example of one or more sets of color conversion data each defining a correspondence before and after color information in an image is converted. The controller 135 transmits the camera library information D10 managing the LUTs in the camera LUT library 30 to the user terminal 10 via the communication module 143 (S32). The controller 135 receives, from the user terminal 10 via the communication module 143, an instruction generated in the user terminal 10 according to a user operation on the camera LUT library 30 based on the camera library information D10 (S33, S35, S37, S39, S41). The controller 135 transmits, to the user terminal 10 via the communication module 143, updated camera library information D10 based on the instruction received from the user terminal 10 (S34, S36, S38, S40).

According to the above digital camera 100, for example, it is possible to receive the instruction to the camera LUT library 30 from the user terminal 10 that generates the instruction based on the transmitted camera library information D10, the instruction being generated according to the user operation and in accordance with the state of the camera LUT library 30. Therefore, for example, the LUTs in the camera LUT library 30 can be easily managed using the user terminal 10.

### Second Embodiment

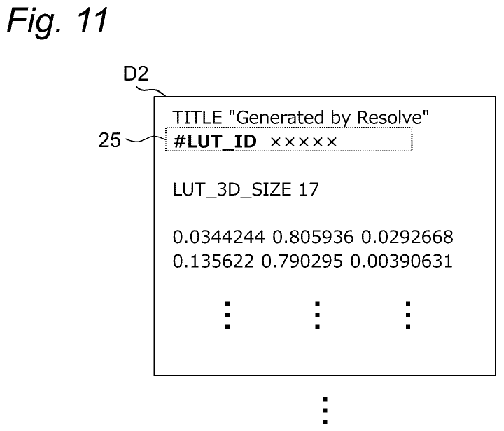

Hereinafter, a second embodiment of the present disclosure will be described with reference to FIGS. 11 to 13. In the first embodiment, according to the camera library information D10 acquired by the user terminal 10 from the digital camera 100, the LUT transfer operation, and the like, are performed according to the user operation on the camera LUT library. In the second embodiment, in the transfer operation of a LUT, the user terminal 10 further determines whether the LUT to be transferred is same as a LUT stored in the camera LUT library 30.

Hereinafter, the user terminal 10 and the digital camera 100 according to the present embodiment will be described while description of configurations and operation similar to those of the user terminal 10 and the digital camera 100 according to the first embodiment will be omitted as appropriate.

FIG. 11 is a view illustrating an example of a LUT file according to the present embodiment. A LUT file D2 illustrated in FIG. 11 includes “TITLE” indicating the name of the LUT described in the LUT file D2, an ID 25 indicating an identifier unique to the LUT, and the like. For example, the ID 25 is provided at the time of creating the LUT, or the like. In the present embodiment, for example, the ID 25 for each LUT may be further managed in the camera library information D10 as illustrated in FIG. 5.

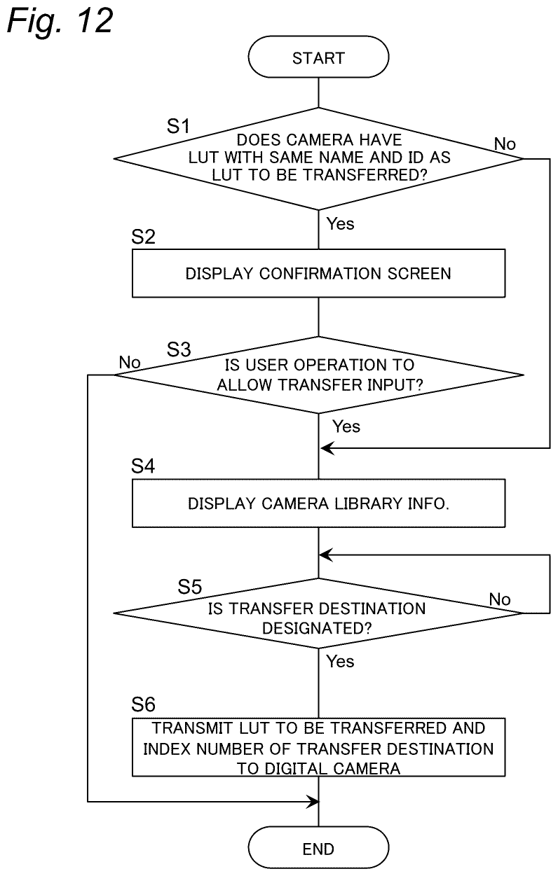

FIG. 12 is a flowchart indicating transfer operation in the user terminal 10 of the present embodiment. With the LUT management function being performed in the user terminal 10, the processing of this flowchart is started in response to the user operation instructing transfer of the LUT, in a state where the camera library information D10 is acquired from the digital camera 100 (S31 and S32 in FIG. 6) (S11). Each process of this flowchart is executed by the controller 11, for example.

The controller 11 determines whether or not a LUT having the same name and ID 25 as the LUT to be transferred is stored in the camera LUT library 30 (S1). For example, the controller 11 makes the determination based on the LUT file D2 of the LUT instructed to be transferred from the terminal LUT dataset D21 and the acquired camera library information D10.

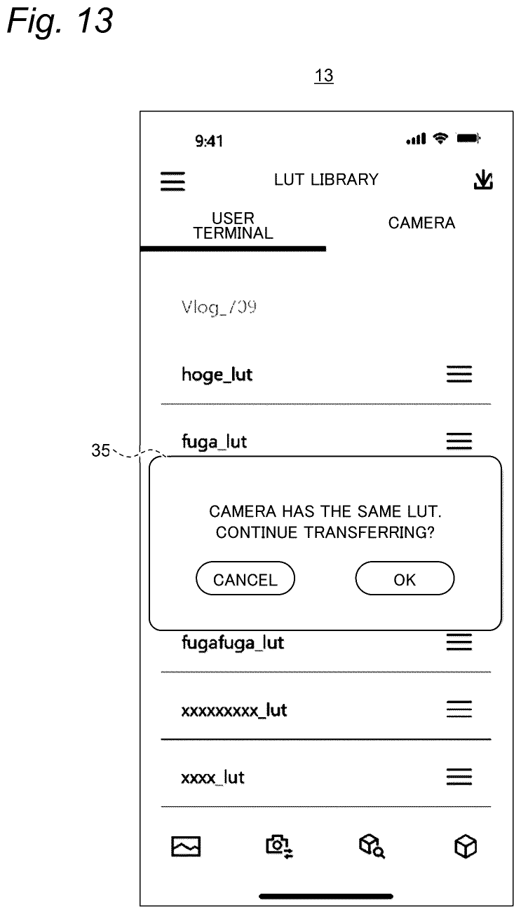

In a case where the LUT having the same name and ID 25 as the LUT to be transferred is present in the camera LUT library 30 (S1: Yes), the controller 11 causes the display 13 to display a confirmation screen that allows the user to select whether or not to permit the transfer, for example (S2). FIG. 13 illustrates a display example of the transfer operation in the user terminal 10 of the present embodiment. In the example of FIG. 13, the display 13 displays a confirmation screen 35 for receiving selection of whether or not to permit the transfer by a user operation of selecting “OK” or “cancel”.

The controller 11 determines whether or not the user operation of permitting the transfer on the confirmation screen 35 is input via the input I/F 14 (S3). For example, in a case where the user operation of permitting the transfer is not input (S3: No), the controller 11 ends the processing of this flowchart.

In a case where the user operation of permitting transfer is input (S3: Yes), the controller 11 causes the display 13 to display the camera library information D10 to receive the user operation designating the transfer destination (S4). For example, an application screen similar to that in FIG. 9C is displayed. Also in a case where the LUT having the same name and ID 25 as the LUT to be transferred is not present in the camera LUT library 30 (S1: No), the processing of the controller 11 proceeds to step S4.

The controller 11 determines whether or not the transfer destination is designated by the user operation input via the input I/F based on the camera library information D10 displayed in step S5 (S5). In a case where the transfer destination is not designated (S5: No), the controller 11 repeats the determination in step S5 at a predetermined cycle.

In a case where the transfer destination is designated (S5: Yes), the controller 11 generates the instruction including the LUT to be transferred and the index number of the transfer destination designated in step S8 in the transfer request and transmits the instruction to the digital camera 100 via the communication I/F 15 (S6). The processing in step S6 corresponds to the processing in step S33 in FIG. 6. Thereafter, the controller 11 ends the processing of this flowchart.

According to the above operation of the user terminal 10, in a case where the LUT having the same name and ID 25 as the LUT to be transferred is present in the camera LUT library 30 (S3: Yes), the user can select whether or not to permit the transfer (S4, S5). Therefore, for example, it is possible to avoid inconvenience that duplicate LUTs are stored at a plurality of different positions of the camera LUT library, so that it is possible to further facilitate management of the LUTs. In addition, it is possible to prevent excessive transfer operation and reduce processing load and communication load between the user terminal 10 and the digital camera 100. This also allows easily managing LUTs in the user terminal 10 and the digital camera 100.

The determination in step S1 is not limited to the above example and may be performed, for example, by transmitting an instruction including the ID 25 of the specified LUT from the user terminal 10 for the LUT in the camera LUT dataset D20 and causing the digital camera 100 to collate the ID 25 of each LUT. In this case, the user terminal 10 can receive a collation result from the digital camera 100 and make the determination.

As described above, in the present embodiment, the user terminal 10 (an example of the electronic device) further includes the display 13 as an example of a display that displays information. Each of the LUTs included in the terminal LUT library 31 and the camera LUT library 30 (examples of the first and second libraries, respectively) include an ID 25 as an example of an identifier identifying each LUT in the plurality of LUTs. Based on the ID 25, when the LUT specified in the terminal LUT library 31 is included in the camera LUT library 30 (S1: Yes), the controller 11 causes the display 13 to display the confirmation screen 35 as an example of predetermined information (S2).

According to the user terminal 10 described above, the user can discriminate a case where the LUT to be transferred to the digital camera 100 is included in the camera LUT library 30 based on the ID 25 of the LUT from the information displayed on the display 13 and can easily manage the LUT to be transferred.

### OTHER EMBODIMENTS

As described above, the first and second embodiments are described as examples of the technique disclosed in the present application. However, the technique in the present disclosure is not limited thereto, and can also be applied to embodiments in which changes, substitutions, additions, omissions, and the like, are made as appropriate. In addition, a new embodiment can be made by combining the components described in the first embodiment. Thus, other embodiments will be exemplified below.

In each of the above embodiments, an example is described in which the LUT management system 1 includes one digital camera 100 and one user terminal 10. The LUT management system according to the present embodiment may include a plurality of digital cameras. Also in this case, for example, the user operation on the camera LUT library 30 of each digital camera can be performed from the user terminal 10, between each digital camera and the user terminal 10, as in each of the above embodiments.

In each of the above embodiments, an example is described in which various operations such as the transfer can be performed for each LUT in the user terminal 10 and the digital camera 100. In the present embodiment, the user terminal 10 is not limited to receiving the user operation on one LUT and may receive the user operation on a plurality of LUTs collectively. For example, instead of the LUT library information in the first embodiment, a plurality of LUTs may be managed in units of folders by a list of names, and the like. For example, the camera LUT library and the terminal LUT library may manage the positions of the LUTs in the LUT datasets D20 and D21 in association with the names of the LUTs for each folder.

For example, in a case where the transfer operation of the LUT is performed in the above embodiment, the transfer request from the user terminal 10 may include the name of the folder to be transferred, the list of the names of the LUTs in the folder, and one or more LUTs in the folder as parameters. In the digital camera 100 of the present embodiment, for example, the number of LUTs that can be stored in the camera LUT library is not limited to 40, and the LUT in the transferred folder may be added to the end of the camera LUT library.

In the first embodiment described above, in the example of FIG. 6, the user terminal 10 transmits the transfer request in response to the user operation to transfer the LUT to the camera LUT library 30 (S11) (S33). In the present embodiment, before the transfer request, the user terminal 10 may transmit information for preparation of transfer such as a notification of the transfer to the digital camera 100 and may receive a response from the digital camera 100.

In the first embodiment described above, in the example of FIG. 6, the digital camera 100 transmits the updated camera library information D10 to the user terminal 10 together with the completion notification. In the present embodiment, the camera library information D10 may be transmitted separately from the completion notification. For example, the user terminal 10 may acquire the updated camera library information D10 from the digital camera 100 before transmitting the instruction according to the next user operation. Further, the updated camera library information D10 may be transmitted to the user terminal 10 when the camera library information D10 is changed in the digital camera 100.

In each of the above embodiments, the example in which the input I/F 14 of the user terminal 10 connects the user terminal 10 and the input equipment is described. The input I/F 14 of the present embodiment may include input equipment such as a touch panel. The input equipment is not limited to the touch panel and may be any one or a combination of a mouse, a keyboard, a pointing device, a controller, a physical button, and the like.

In each of the above embodiments, the example in which the LUT library is stored in the flash memory 145 in the digital camera 100 is described. In the present embodiment, an example of the storage that stores the LUTs in the digital camera 100 is not limited to the flash memory 145 and may be the buffer memory 125.

In each of the above embodiments, the smartphone, the tablet terminal, the personal computer, and the like, are described as examples of the electronic device, but the electronic device is not limited thereto. The electronic device of the present disclosure may be an information processing device having a communication function and capable of receiving input according to a user operation.

In each of the above embodiments, the digital camera 100 including the optical system 110 is exemplified. The imaging apparatus of the present embodiment does not have to include the optical system 110 and may be, for example, an interchangeable lens type camera.

In each of the above embodiments, the digital camera is described as an example of the imaging apparatus, but the imaging apparatus is not limited thereto. The imaging apparatus of the present disclosure may be an electronic device (e.g., a video camera, a smartphone, a tablet terminal, or the like) that has an image capturing function and a communication function, and performs image processing with color conversion data such as a LUT.

### EXAMPLE OF ASPECTS

Hereinafter, various aspects according to the present disclosure will be listed.

Aspect 1 provides an electronic device comprising: a communication circuit that communicates data with the imaging apparatus; an input interface that receives input by a user operation; a controller that controls the communication circuit; and a storage that stores a first library including one or more sets of color conversion data each defining a correspondence before and after color information in an image is converted. The imaging apparatus stores a second library including one or more sets of the color conversion data managed in the imaging apparatus. The controller receives management information from the imaging apparatus via the communication circuit, the management information managing the color conversion data in the second library, and generates an instruction according to a user operation on the second library to transmit the instruction to the imaging apparatus via the communication circuit, based on the management information received from the imaging apparatus.

Aspect 2 provides the electronic device according to aspect 1, wherein the controller transmits, via the communication circuit, designated color conversion data in the first library to the imaging apparatus based on the management information, in accordance with the instruction according to the user operation designating the color conversion data to be added from the first library to the second library.

Aspect 3 provides the electronic device according to aspect 2, wherein the controller transmits the designated color conversion data from the first library to a position selected in the second library, based on the management information, the position being selected by the user operation among positions where a plurality of sets of the color conversion data are stored in the second library.

Aspect 4 provides the electronic device according to aspects 2 or 3, further comprising a display that displays information. The color conversion data included in the first library and the second library includes an identifier identifying each set of the color conversion data in a plurality of sets of the color conversion data. The controller causes the display to display, based on the identifier, predetermined information when the designated color conversion data in the first library is included in the second library.

Aspect 5 provides the electronic device according to any one of aspects 1 to 4, wherein the controller requests designated color conversion data in the second library from the imaging apparatus based on the management information, to receive the designated color conversion data from the imaging apparatus via the communication circuit, in accordance with the instruction according to the user operation designating the color conversion data to be acquired from the second library.

Aspect 6 provides the electronic device according to any one of aspects 1 to 5, wherein the management information includes positions where a plurality of sets of the color conversion data are stored in the second library. The controller generates, according to the user operation changing the positions, the instruction including a correspondence before and after the positions are changed, and transmits the instruction to the imaging apparatus via the communication circuit, based on the management information.

Aspect 7 provides the electronic device according to any one of aspects 1 to 6, wherein the management information includes a name associated with the color conversion data in the second library. The controller generates, according to the user operation changing the name of the color conversion data in the second library, the instruction including the changed name of the color conversion data, and transmits the instruction to the imaging apparatus via the communication circuit, based on the management information.

Aspect 8 provides the electronic device according to any one of aspects 1 to 7, wherein the controller generates the instruction according to the user operation specifying the color conversion data to be deleted from the second library, and transmits the instruction to the imaging apparatus via the communication circuit, based on the management information.

Aspect 9 provides the electronic device according to any one of aspects 1 to 8, wherein the controller requests the management information from the imaging apparatus to receive the management information from the imaging apparatus, via the communication circuit.

Aspect 10 provides an imaging apparatus for communicating with an external electronic device, the imaging apparatus comprising: a communication circuit that communicates data with the electronic device; a storage that stores a library including one or more sets of color conversion data each defining a correspondence before and after color information in an image is converted; and a controller that controls the communication circuit. The controller transmits, to the electronic device via the communication circuit, management information managing the color conversion data in the library, receives, from the electronic device via the communication circuit, an instruction generated in the electronic device according to a user operation on the library based on the management information, and transmits, to the electronic device via the communication circuit, updated management information based on the instruction received from the electronic device.

As described above, the embodiment is described as an exemplification of the technique in the present disclosure. For this purpose, the accompanying drawings and the detailed description are provided.

Accordingly, the constituent elements described in the accompanying drawings and the detailed description may include not only a constituent element essential for solving the problem, but also a constituent element not essential for solving the problem in order to exemplify the technique. For this reason, it should not be recognized that those non-essential constituent elements are essential just because those non-essential constituent elements are described in the accompanying drawings and the detailed description.

Further, the above-described embodiment is provided to exemplify the technique in the present disclosure, and hence it is possible to make various changes, replacements, additions, omissions, and the like within the scope of claims or the scope equivalent to claims.

The present disclosure is applicable to an electronic device and an imaging apparatus capable of communicating with each other and using color conversion data such as a LUT applied to an image.

What is claimed is:

1. An electronic device for communicating with an external imaging apparatus, the electronic device comprising:
a communication circuit that communicates data with the imaging apparatus;
an input interface that receives input by a user operation;
a controller that controls the communication circuit; and
a storage that stores a first library including one or more sets of color conversion data each defining a correspondence before and after color information in an image is converted,
wherein the imaging apparatus stores a second library including one or more sets of the color conversion data managed in the imaging apparatus, and
the controller
receives management information from the imaging apparatus via the communication circuit, the management information managing the color conversion data in the second library, and
generates an instruction according to a user operation on the second library to transmit the instruction to the imaging apparatus via the communication circuit, based on the management information received from the imaging apparatus.

2. The electronic device according to claim 1, wherein the controller transmits, via the communication circuit, designated color conversion data in the first library to the imaging apparatus based on the management information, in accordance with the instruction according to the user operation designating the color conversion data to be added from the first library to the second library.

3. The electronic device according to claim 2, wherein the controller transmits the designated color conversion data from the first library to a position selected in the second library, based on the management information, the position being selected by the user operation among positions where a plurality of sets of the color conversion data are stored in the second library.

4. The electronic device according to claim 2, further comprising a display that displays information,
wherein the color conversion data included in the first library and the second library includes an identifier identifying each set of the color conversion data in a plurality of sets of the color conversion data, and
the controller causes the display to display, based on the identifier, predetermined information when the designated color conversion data in the first library is included in the second library.

5. The electronic device according to claim 1, wherein the controller requests designated color conversion data in the second library from the imaging apparatus based on the management information, to receive the designated color conversion data from the imaging apparatus via the communication circuit, in accordance with the instruction according to the user operation designating the color conversion data to be acquired from the second library.

6. The electronic device according to claim 1, wherein
the management information includes positions where a plurality of sets of the color conversion data are stored in the second library, and
the controller generates, according to the user operation changing the positions, the instruction including a correspondence before and after the positions are changed, and transmits the instruction to the imaging apparatus via the communication circuit, based on the management information.

7. The electronic device according to claim 1, wherein
the management information includes a name associated with the color conversion data in the second library, and
the controller generates, according to the user operation changing the name of the color conversion data in the second library, the instruction including the changed name of the color conversion data, and transmits the instruction to the imaging apparatus via the communication circuit, based on the management information.

8. The electronic device according to claim 1, wherein the controller generates the instruction according to the user operation specifying the color conversion data to be deleted from the second library, and transmits the instruction to the imaging apparatus via the communication circuit, based on the management information.

9. The electronic device according to claim 1, wherein the controller requests the management information from the imaging apparatus to receive the management information from the imaging apparatus, via the communication circuit.

10. An imaging apparatus for communicating with an external electronic device, the imaging apparatus comprising:
a communication circuit that communicates data with the electronic device;
a storage that stores a library including one or more sets of color conversion data each defining a correspondence before and after color information in an image is converted; and
a controller that controls the communication circuit,
wherein the controller
transmits, to the electronic device via the communication circuit, management information managing the color conversion data in the library,
receives, from the electronic device via the communication circuit, an instruction generated in the electronic device according to a user operation on the library based on the management information, and
transmits, to the electronic device via the communication circuit, updated management information based on the instruction received from the electronic device.
